(19) United States
(12) Patent Application Publication
(10) Pub. No.: US 2012/0181779 A1
(43) Pub. Date: Jul. 19, 2012

(54) WHEELCHAIR AND BED

(76) Inventors: Shohei Tsukada, Osaka (JP); Yohei Kume, Osaka (JP); Hideo Kawakami, Osaka (JP); Tohru Nakamura, Osaka (JP); Toshihide Ueda, Osaka (JP)

(21) Appl. No.: 13/498,692

(22) PCT Filed: Jun. 20, 2011
(86) PCT No.: PCT/JP2011/003502

§ 371 Date: Mar. 28, 2012

(30) Foreign Application Priority Data
Jun. 21, 2010 (JP) 2010-140087

(51) Int. Cl. A61G 5/00; A61G 7/05

(52) U.S. Cl. 280/648; 280/647

(57) ABSTRACT

In a bed including a wheelchair and a bed main body portion, the wheelchair has a seating bottom portion composed of bendably coupling a plurality of divided members, a chair bottom support member supporting the seating bottom portion, the chair bottom support member for changing a shape of a leg bottom part in conjunction with inclination of a back bottom part, a chair base portion fixing the chair bottom support member, front casters provided in the chair base portion, the front casters being capable of freely changing the direction, both side wheel bottom support members axially supported on the chair base portion, rear casters provided in one ends of the both side wheel bottom support members, the rear casters being capable of freely changing the direction, traveling wheels provided in the other ends of the both side wheel bottom support members, whose traveling direction is fixed to the straight-moving direction, and caster links coupling parts of the both side wheel bottom support members on the side of the rear casters and the back bottom part of the chair bottom support member.

### TECHNICAL FIELD

The present invention relates to a wheelchair and a bed in which a part thereof can be separated as a wheelchair.

### BACKGROUND ART

Upon nursing care of a bedridden aged person or an ailing person (hereinafter, collectively abbreviated as the care-receiver), a transferring task between a wheelchair and a bed is a heavy burden on a caregiver. In order to reduce the burden on the caregiver, there is a combination bed in which a part of the bed is separated so as to be transformed into a wheelchair.

Such a combination bed is composed of combining a bed main body portion and a wheelchair in a flat posture. In order to combine the wheelchair with the bed main body portion, there is a need for laterally placing the wheelchair in the flat posture alongside the bed main body portion without any gap inbetween. For a purpose of laterally placing the wheelchair alongside the bed main body portion without any gap inbetween, a wheelchair capable of laterally moving is proposed (for example, refer to Patent Literature 1).

FIGS. 6A and 6B are side views of a conventional wheelchair 1. FIG. 6A is a side view of the wheelchair 1 at the time of normal use, and FIG. 6B is a side view of the wheelchair 1 at the time of omnidirectional movement. The wheelchair 1 has casters 2 on the front side (on the left side in FIGS. 6A and 6B), has traveling wheels 3 in the center, and has casters 4 on the rear side (on the right side in FIGS. 6A and 6B). Although the directions of the casters 2, 4 can be changed to the arbitrary direction, the direction of the traveling wheels 3 cannot be changed. As shown in FIG. 6A, in the case where the care-receiver is moved by this wheelchair 1 being at the time of normal use, the casters 2 and the traveling wheels 3.are grounded. At the time, the casters 4 are not grounded but slightly floated up from the ground. When the wheelchair 1 travels with combination of the casters 2 and the traveling wheels 3, due to the fixed traveling direction of the traveling wheels 3, the wheelchair can stably travel without shifting in the left and right directions. As shown in FIG. 6B, in this wheelchair 1, when a movable frame operating handle 5 is pulled up, the casters 4 are grounded, so that the traveling wheels 3 are floated up. When the traveling wheels 3 are floated up by manually moving the movable frame operating handle 5, the wheelchair is supported only by the casters 2, 4 so as to be moved in the direction (the lateral direction) vertical to the traveling direction. Thereby, the wheelchair 1 can be laterally placed alongside the bed main body portion.

### CITATION LIST

### Patent Literature

[Patent Literature 1] Japanese Unexamined Patent Publication No. 2006-181105

### SUMMARY OF INVENTION

### Technical Problem

However, the conventional wheelchair 1 is only assumed to be changed to a flat posture after being laterally moved as the wheelchair. That is, the conventional wheelchair 1 is only assumed to be laterally moved in a wheelchair state. Therefore, with a configuration of the conventional wheelchair 1, gravity center balance is favorable in the wheelchair state. However, there is a possibility that the gravity center balance is deteriorated in the flat posture.

In order to enable the conventional wheelchair 1 to laterally move in the wheelchair state, there is a need for manually operating the movable frame operating handle 5 in the wheelchair state so as to allow the casters 4 to be grounded. Therefore, in the wheelchair state, the casters 4 are grounded on the rear side of a waist, so that a turning radius of the wheelchair 1 is increased. When the turning radius of the wheelchair 1 is increased, for example, in a narrow interior space, there is a case where an operability of the wheelchair 1 is deteriorated.

Furthermore, the conventional wheelchair 1 only has a function as the wheelchair.

In the conventional wheelchair 1, at the time of laterally moving the wheelchair 1 for combination, there is a problem that an operating of the movable frame operating handle 5 takes time and efforts.

Therefore, an object of the present invention is to provide a bed to be combined with a wheelchair and a wheelchair in which the operability is favorable in the wheelchair state (in a seating state), and the wheels can be switched with less time and efforts.

### Solution To Problem

In order to achieve the above object, the present invention is configured as below.

According to one aspect of the present invention, there is provided a wheelchair, comprising:

a seating bottom portion composed of a back bottom part, a seating bottom part, and a leg bottom part which are bendable to each other;

a chair bottom support member composed of a chair back bottom support member supporting the back bottom part and a chair leg bottom support member supporting the leg bottom part;

a link member for actuating the chair leg bottom support member in conjunction with an action of the chair back bottom support member;

a chair base portion coupled to the chair bottom support member;

front wheels serving as freewheels provided in a front part of the chair base portion;

wheel bottom support members whose intermediate parts are axially supported on a rear part of the chair base portion;

rear wheels serving as freewheels provided in one ends of the wheel bottom support members;

traveling wheels serving as fixed wheels provided in other ends of the wheel bottom support members; and

wheel links coupling rear wheel sides of the wheel bottom support members and the chair back bottom support member,

wherein in a case where the seating bottom portion is in a seating posture, lower surfaces of the traveling wheels are positioned on a lower side of a plane composed of lower surfaces of the rear wheels and lower surfaces of the front wheels, and

in a case where the seating bottom portion is in a flat posture, the lower surfaces of the traveling wheels are positioned on an upper side of the plane composed of the lower surfaces of the rear wheels and the lower surfaces of the front wheels.

According to another aspect of the present invention, there is provided a wheelchair, comprising:

a seating bottom portion composed of a back bottom part, a seating bottom part, and a leg bottom part which are bendable to each other;

a chair bottom support member composed of a chair back bottom support member supporting the back bottom part and a chair leg bottom support member supporting the leg bottom part;

a link member that actuates the chair leg bottom support member in conjunction with an action of the chair back bottom support member;

a chair base portion coupled to the chair bottom support member;

front wheels serving as freewheels provided in a front part of the chair base portion;

rear wheel bottom support members whose ends are axially supported on a rear part of the chair base portion;

a rear wheel serving as a freewheel provided in one end of the rear wheel bottom support member;

traveling wheels serving as fixed wheels provided on a rear side of the chair base portion; and

wheel links coupling rear wheel sides of the rear wheel bottom support members and the back bottom part of the chair bottom support member,

wherein in a case where the seating bottom portion is in a seating posture, lower surfaces of the traveling wheels are positioned on a lower side of a plane composed of lower surfaces of the rear wheels and lower surfaces of the front wheels, and

in a case where the seating bottom portion is in a flat posture, the lower surfaces of the traveling wheels are positioned on an upper side of the plane composed of the lower surfaces of the rear wheels and the lower surfaces of the front wheels.

According to still another aspect of the present invention, there is provided a bed, comprising:

the wheelchair according to the above aspect; and

a bed main body portion with which the wheelchair is separably combined.

### Advantageous Effects Of Invention

With such a configuration, in the bed to be combined with the wheelchair and the wheelchair of the present invention, gravity center balance is stabilized in the flat posture, an operability is favorable in the wheelchair state (in the seating state), and the wheels can be switched with less time and efforts.

### BRIEF DESCRIPTION OF DRAWINGS

These and other objects and features of the present invention will be elucidated from the following description relating to embodiments regarding the attached drawings. In the drawings,

FIG. 1 is a perspective view of a separated combination bed in a first embodiment of the present invention;

FIG. 2A is a side view of a wheelchair in a seating posture in the first embodiment;

FIG. 2B is a side view of the wheelchair in a flat posture in the first embodiment;

FIG. 2C is a partially enlarged side view of a wheel switching mechanism of the wheelchair in the first embodiment;

FIG. 3 is a perspective view of the combination bed prepared to be combined in the first embodiment;

FIG. 4 is a perspective view of the combined combination bed in the first embodiment;

FIG. 5 is a partially enlarged view of a wheel switching mechanism of the wheelchair in a second embodiment of the present invention;

FIG. 6A is a side view of a conventional wheelchair at the time of normal use; and

FIG. 6B is a side view of the conventional wheelchair at the time of omnidirectional movement.

### DESCRIPTION OF EMBODIMENTS

Hereinafter, embodiments of the present invention will be described with reference to the drawings. It should be noted that the same constituent elements will be given the same reference numerals, and description thereof will sometimes be omitted. For easy understanding, the drawings are schematic focusing on the constituent elements.

### First Embodiment

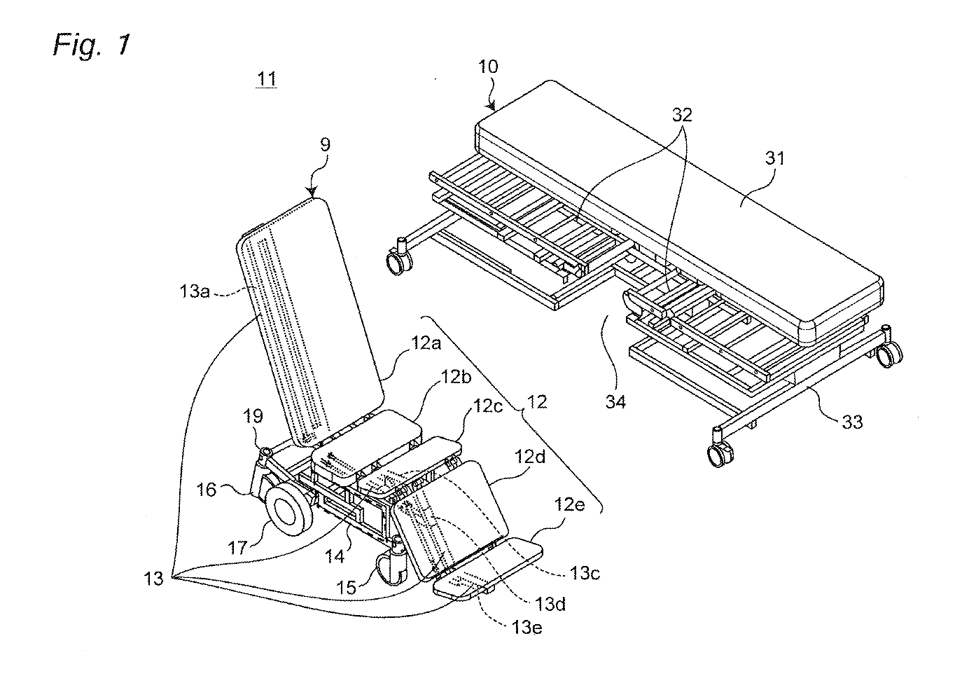

FIG. 1 is a perspective view of a separated bed 11 in a first embodiment of the present invention. The bed 11 includes a wheelchair 9 and a bed main body portion 10.

As shown in FIG. 1, the bed 11 is separated into the wheelchair 9 and the bed main body portion 10. The wheelchair can be utilized as a single body wheelchair. In a case of a seating posture (a wheelchair state) as shown in FIG. 1, the wheelchair 9 cannot be omnidirectionally moved. However, by changing the seating posture to a flat posture, the wheelchair can be omnidirectionally moved including lateral movement.

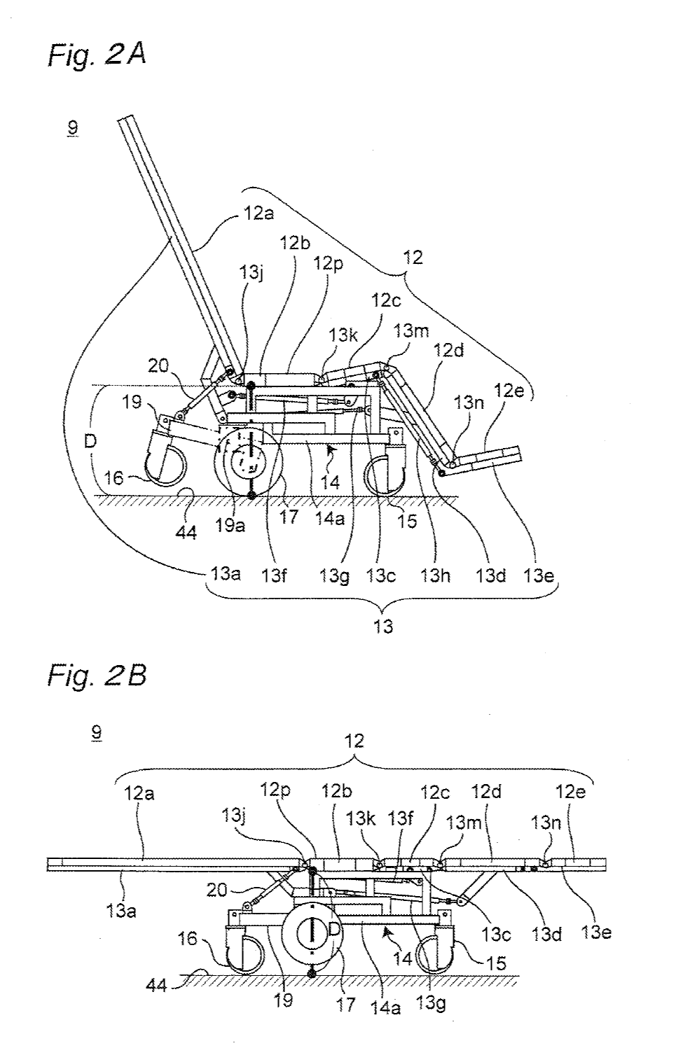

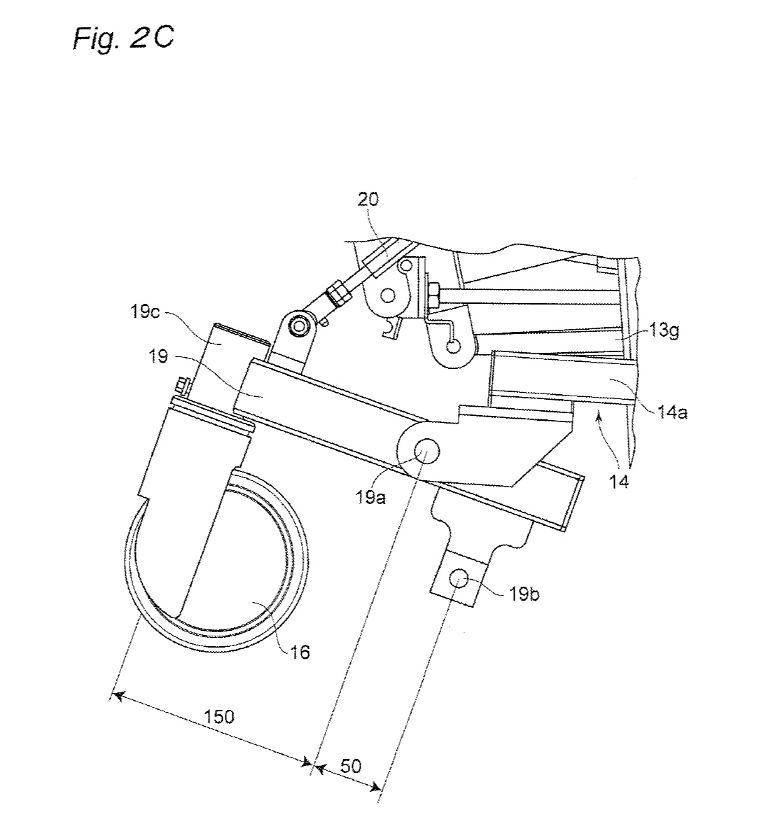

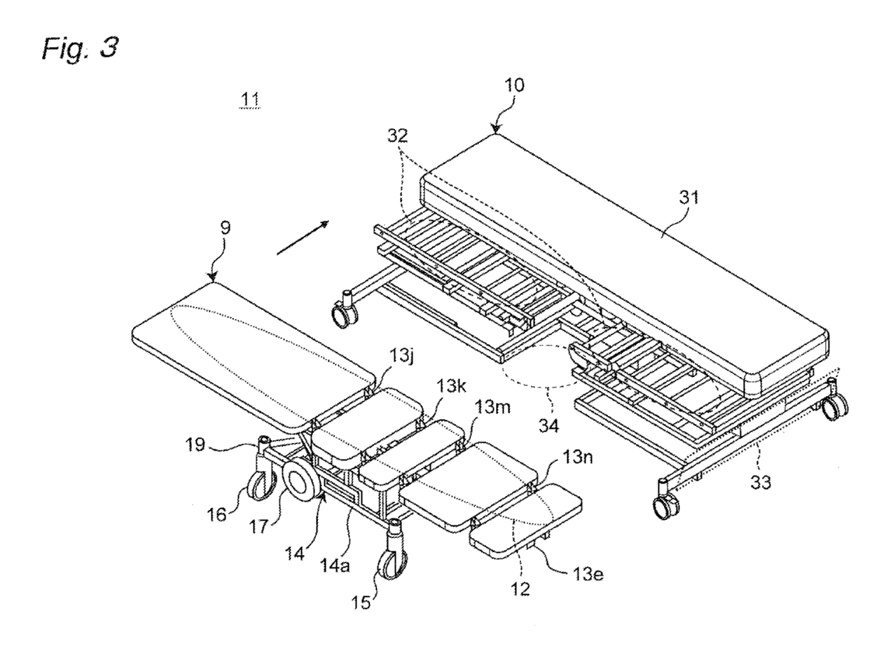

The wheelchair 9 has a seating bottom portion 12 composed of bendably coupling a back bottom part, a seating bottom part, and a leg bottom part, a chair bottom support member (chair guide portion) 13 supporting the seating bottom portion 12, the chair bottom support member 13 that changes a posture of the leg bottom part in conjunction with inclination of the back bottom part, and a chair base portion 14 coupled to the chair bottom support member 13 for fixing the chair bottom support member 13. Here, the back bottom part corresponds to a chair back bottom member 12a supported by a chair back bottom support member (chair back guide portion) 13a in FIGS. 2A to 2B. The seating bottom part corresponds to a chair waist bottom member 12b of FIGS. 2A to 2B. The leg bottom part corresponds to a chair knee bottom member 12c supported by a chair knee bottom support member (chair knee guide portion) 13c in FIGS. 2A to 2B, a chair leg first bottom member 12d supported by a chair leg first bottom support member (chair leg first guide portion) 13d, and a chair leg second bottom member 12e supported by a chair leg second bottom support member (chair leg second guide portion) 13e. That is, the seating bottom portion 12 is composed of the chair back bottom member 12a, the chair waist bottom member 12b, the chair knee bottom member 12c, the chair leg first bottom member 12d, and the chair leg second bottom member 12e. Among these members, the adjacent members are bendably coupled to each other via coupling parts of thin parts or hinge parts. The coupling parts of the thin parts are bendable by making the parts thinner than thickness of each of the bottom members composing the seating bottom portion 12, or the like. The chair back bottom member 12a is a part to be brought into contact with a back of a care-receiver. The chair waist bottom member 12b is a part to be brought into contact with a waist of the care-receiver. The chair knee bottom member 12c is a part to be brought into contact with thighs of the care-receiver. The chair leg first bottom member 12d is a part to be brought into contact with legs of the care-receiver. The chair leg second bottom member 12e is a part to be brought into contact with heels of the care-receiver. The chair back bottom member 12a, the chair waist bottom member 12b, the chair knee bottom member 12c, the chair leg first bottom member 12d, and the chair leg second bottom member 12e generally have a cushion function. The chair leg second bottom member 12e serves as a footrest when the wheelchair 9 is in the seating posture.

Further, the wheelchair 9 has front casters 15, both side wheel bottom support members 19, traveling wheels 17, rear casters 16, and caster links (wheel links) 20.

The front casters 15 function as one example of a pair of front wheels provided in a front end of the chair base portion 14. The both side wheel bottom support members 19 serving as one example of wheel bottom support members are axially supported on a rear part of the chair base portion 14. The rear casters 16 function as one example of a pair of rear wheels provided in one ends (such as rear ends) of the both side wheel bottom support members 19. The pair of traveling wheels 17 is provided in the other ends (such as front ends) of the both side wheel bottom support members 19. The caster links (the wheel links) 20 couple upper ends of the both side wheel bottom support members 19 on the side of the rear casters 16 with a back bottom part of the chair bottom support member 13. Both the front casters 15 and the rear casters 16 are free casters (freewheels) whose traveling direction can be freely changed. The traveling wheels 17 are fixed casters (fixed wheels) whose traveling direction is fixed to the straight-moving direction.

FIG. 2A is a side view of the wheelchair 9 in the seating posture (the wheelchair state), and FIG. 2B is a side view of the wheelchair 9 in the flat posture. FIG. 2C is a partially enlarged side view of a wheel switching mechanism. With FIGS. 2A to 2C, a posture change conjunction mechanism of the seating bottom portion of the wheelchair 9, and the wheel switching mechanism following the conjunction mechanism will be described.

Firstly, the posture change conjunction mechanism of the seating bottom portion will be described. The chair bottom support member 13 supporting the seating bottom portion 12 is composed of the chair back bottom support member 13a supporting the chair back bottom member 12a, the chair knee bottom support member 13c supporting the chair knee bottom member 12c, the chair leg first bottom support member 13d supporting the chair leg first bottom member 12d, the chair leg second bottom support member 13e supporting the chair leg second bottom member 12e, a first link portion 13f, a second link portion 13g, and a footrest conjunction link 13h. The seating bottom portion 12 is composed of at least the back bottom part 12a, the seating bottom part 12b, and the leg bottom part 12c, 12e, 12e so as to be bendable to each other. The chair bottom support member 13 is composed of at least the chair back bottom support member 13a supporting the back bottom part 12a and the chair leg bottom support member 13d, 13e supporting the leg bottom part 12c, 12e, 12e. Here, the chair leg first bottom support member 13d and the chair leg second bottom support member 13e compose the chair leg bottom support member. The first link portion 13f, the second link portion 13g, and the footrest conjunction link 13h compose a link member. The chair back bottom support member 13a and the chair knee bottom support member 13c are bendably coupled to the chair waist bottom member 12b via chair first and second bending portions 13j, 13k. The chair leg first bottom support member 13d is bendably coupled to the chair knee bottom support member 13c via a chair third bending portion 13m, and the chair leg second bottom support member 13e is bendably coupled to the chair leg first bottom support member 13d via a chair fourth bending portion 13n. The chair base portion 14 supports the chair waist bottom member 12b from the lower side.

Since the chair waist bottom member 12b, the chair back bottom support member 13a, and the chair knee bottom support member 13c are coupled to one another, position displacement is not generated between the chair bottom member 12 and the chair bottom support member 13.

The first link portion 13f couples the chair back bottom support member 13a and the chair knee bottom support member 13c. The first link portion 13f is a link for lifting the chair knee bottom support member 13c by lifting the chair back bottom support member 13a, and bringing down the chair knee bottom support member 13c by bringing down the chair back bottom support member 13a.

The second link portion 13g couples the chair back bottom support member 13a and the chair leg first bottom support member 13d. The second link portion 13g is a link for suspending down the chair leg first bottom support member 13d by lifting the chair back bottom support member 13a, and bringing up the suspended-down chair leg first bottom support member 13d by bringing down the chair back bottom support member 13a.

The footrest conjunction link 13h couples the chair knee bottom support member 13c and the chair leg second bottom support member 13e to one another. The footrest conjunction link 13h is a link for moving the chair knee bottom support member 13c and the chair leg second bottom support member 13e so as to make the chair knee bottom support member 13c and the chair leg second bottom support member 13e parallel.

With such a configuration, in the wheelchair 9 in the seating posture, when the chair back bottom member 12a is brought down until forming a horizontal surface, the chair back bottom support member 13a is also brought down until forming a horizontal surface. In the wheelchair 9 in the seating posture, the chair knee bottom support member 13c, the chair leg first bottom support member 13d, and the chair leg second bottom support member 13e serving as the leg bottom part of the chair bottom Support member 13 interlock and form a horizontal surface in conjunction with movement of the chair back bottom support member 13a serving as the back bottom part of the chair bottom support member 13. As a result, the seating bottom portion 12 forms a horizontal surface, so that the wheelchair 9 is brought into the flat posture.

Next, the wheel switching mechanism in conjunction with posture change of the seating bottom portion will be described.

An intermediate part of the both side wheel bottom support member 19 is rotatably axially supported on the rear part of the chair base portion 14 by a rotation shaft 19a. A traveling wheel attachment portion 19b is provided on the front side of the rotation shaft 19a of the both side wheel bottom support member 19, so that the traveling wheel 17 is attached. A rear caster attachment portion 19c is provided on the rear side of the rotation shaft 19a of the both side wheel bottom support member 19, so that the rear caster 16 is attached. A part of the both side wheel bottom support member 19 in the vicinity of the rear caster attachment portion 19c and a part of the chair back bottom support member 13a in the vicinity of the chair first bending portion 13j are coupled by the rod shape caster link 20 in such a manner that the both side wheel bottom support member 19 is in conjunction with the movement of the chair back bottom support member 13a.

A characteristic of this wheel switching mechanism is that while the both side wheel bottom support member 19 is forward and reverse pivoted relative to the chair base portion 14, a pivoting point of the both side wheel bottom support member 19 is switched between a rotation shaft of the traveling wheel 17 and a rotation shaft of the rear caster 16.

That is, when the seating posture is changed to the flat posture, the both side wheel bottom support member 19 is pivoted about the rotation shaft of the traveling wheel 17 until the rear caster 16 is grounded: Meanwhile after the rear caster 16 is grounded, the both side wheel bottom support member 19 is pivoted about the rotation shaft of the rear caster 16, so that the traveling wheel 17 is brought up and the traveling wheel 17 is brought away from the ground. During this pivoting action, the both side wheel bottom support member 19 is pivoted about a fulcrum part (the rotation shaft) 19a relative to the chair base portion 14.

Conversely, when the flat posture is changed to the seating posture, the both side wheel bottom support member 19 is pivoted about the rotation shaft of the rear caster 16 until the traveling wheel 17 is grounded. Meanwhile, after the traveling wheel 17 is grounded, the both side wheel bottom support member 19 is pivoted about the rotation shaft of the traveling Wheel 17, so that the rear caster 16 is brought up. During this pivoting action, the both side wheel bottom support member 19 is pivoted about the fulcrum part (the rotation shaft) 19a relative to the chair base portion 14.

Further description will be given below.

Supposing when the chair back bottom member 12a is lifted from the flat posture in FIG. 2B to the seating posture in FIG. 2A after the wheelchair 9 and the bed main body portion 10 are separated. At this time, by lifting from the flat posture to the seating posture, the chair back bottom support member 13a is pivoted clockwise in FIG. 2B about the chair first bending portion 13j. By this pivoting action, at the beginning a rear part of the both side wheel bottom support member 19 allows the rear caster 16 to be grounded on a ground (or an installment surface of the wheelchair 9 and the bed main body portion 10) 44 by the caster link 20. After that, the both side wheel bottom support member 19 is pivoted about the rotation shaft of the rear caster 16, so that the fulcrum part (the rotation shaft) 19a is lowered relative to the chair base portion 14. Since the fulcrum part (the rotation shaft) 19a is lowered, the traveling wheel 17 is grounded on the ground 44. After that, since the both side wheel bottom support member 19 is pulled by the caster link 20, the both side wheel bottom support member 19 is pivoted clockwise about the fulcrum part (the rotation shaft) 19a relative to the chair base portion 14. As a result of this pivoting, the rear caster 16 is brought up and floated up from the ground 44. Further, since the chair back bottom support member 13a performs a pivoting action to the seating posture, the both side wheel bottom support member 19 pulled by the caster link 20 is pivoted about the rotation shaft of the grounded traveling wheel 17 and brought up, so as to bring up the fulcrum part (the rotation shaft) 19a relative to the ground 44. As a result, when the fiat posture is changed to the seating posture, a rear seating height of the chair waist bottom member 12b (seating height on the side of the chair back bottom member 12a) is firstly lowered and then brought up again in comparison to a front seating height (seating height on the side of the chair knee bottom member 12c). When the wheelchair 9 is changed to the seating posture in the end, the chair waist bottom member 12b is at the same height as the flat posture.

That is, in the wheelchair 9 in the seating posture, as shown in FIG. 2A, lower surfaces of the traveling wheels 17 are positioned on the lower side (on the side of the ground 44) of a plane composed of lower surfaces (surfaces on the side of the ground 44) of the two front casters 15 and lower surfaces (surfaces on the side of the ground 44) of the two rear casters 16. Therefore, in the wheelchair 9 in the seating posture, the front casters 15 and the traveling wheels 17 are grounded.

Meanwhile, in the wheelchair 9 in the flat posture, as shown in FIG. 2B, the lower surfaces of the traveling wheels 17 are positioned on the upper side (on the side of the wheelchair 9 relative to the ground 44) of the plane composed of the lower surfaces of the two front casters 15 and the lower surfaces of the two rear casters 16. Therefore, in the wheelchair 9 in the flat posture, the front casters 15 and the rear casters 16 are grounded.

In such a way, in the case where the wheelchair is changed to the seating posture and the traveling wheels 17 are brought into contact with the ground 44 instead of the rear casters 16, wheels supporting the wheelchair 9 are combination of the traveling wheels 17 serving as the fixed wheels and the front casters 15 serving as the freewheels. Therefore, when the wheelchair 9 in the seating posture is moved, the wheelchair 9 can stably travel without shifting in the left and right directions

When the chair back bottom member 12a is brought down from the seating posture in FIG. 2A to the flat posture in FIG. 2B for preparation for combining the wheelchair 9 and the bed main body portion 10, the chair back bottom member 12a is pivoted anticlockwise in FIG. 2A about the chair first bending portion 13j. By this pivoting action, the rear parts of the both side wheel bottom support members 19 are pushed by the caster links 20. As a result, firstly, the fulcrum parts (the rotation shafts) 19a are lowered by pivoting the both side wheel bottom support members 19 about the rotation shafts of the traveling wheels 17, and the both side wheel bottom support members 19 are pivoted about the fulcrum parts (the rotation shafts) 19a relative to the chair base portion 14. After the rear casters 16 are pushed down by this pivoting of the both side wheel bottom support members 19 and the rear casters 16 are brought into contact with the ground 44, by further pivoting the both side wheel bottom support members 19 about the rotation shaft of the rear casters 16, the traveling wheels 17 are brought up and floated up from the ground 44, so that the traveling wheels 17 are brought away from the ground. As a result, when the seating posture is changed to the flat posture, the rear seating height of the chair waist bottom member 12b is not particularly changed in comparison to the front seating height and remains along a horizontal surface: In such a way, in the case where the rear casters 16 are brought into contact with the ground 44 instead of the traveling wheels 17, the wheels supporting the wheelchair 9 in the fiat posture are the front casters 15 and the rear casters 16. At this time, the wheelchair 9 in the flat posture is combination of the front casters 15 serving as the freewheels and the rear casters 16 serving as the freewheels, so that the wheelchair 9 can be omnidirectionally moved. By laterally moving the wheelchair 9, the wheelchair 9 changed to thy flat posture and the bed main body portion 10 can be closely attached and coupled to each other.

In the case where the seating posture is changed to the flat posture, in a process of switching the rear casters 16 and the traveling wheels 17, firstly, in FIG. 2A, in a state where the traveling wheels 17 are grounded on the ground 44, the both side wheel bottom support members 19 are pushed downward by the caster links 20, and the both side wheel bottom support members 19 are pivoted anticlockwise about the rotation shafts of the traveling wheels 17, so that the fulcrum parts (the rotation shafts) 19a of the chair base portion 14 are lowered. As a result, until the rear casters 16 are grounded on the ground 44, the rear seating height D of the chair waist bottom member 12b is once lower than the rear seating height D of the chair waist bottom member 12b at the time of the seating posture. Then, after the rear casters 16 are grounded, the rear casters 16 are pushed downward by the caster links 20, the both side wheel bottom support members 19 are pivoted anticlockwise about the rotation shafts of the rear casters 16, and the fulcrum parts (the rotation shafts) 19a are brought up relative to the ground 44, so that the rear casters 16 are brought away from the ground. As a result, as shown as the flat posture in FIG. 2B, the lowered rear seating height D is brought up again to the rear seating height D of the chair waist bottom member 12b at the time of the seating posture.

Here, by adjusting lengths from the fulcrum part 19a to the traveling wheel 17 and to the rear caster 16 in such a manner that the height of the rear seating height D is the same between the seating posture and the flat posture, the chair waist bottom member 12b can be a horizontal surface without inclining forward. In order to perform this adjustment, for example, the “length from the fulcrum part 19a to the traveling wheel 17″: the “length from the fulcrum part 19a to the rear caster 16″ may be equal to 50 mm:150 mm, that is, 1:3.

With the above configuration, in both states where the seating bottom portion 12 is in the seating posture and in the flat posture, an arrangement surface 12p along a horizontal surface of the chair waist bottom member 12b of the seating bottom portion 12 is parallel to a support frame 14a of the chair base portion 14 supporting the front casters 15 and the rotation shafts 19a serving as axially supporting parts of the both side wheel bottom support members 19. As a result, in both the states of the seating posture and the flat posture, the care-receiver can be stably supported by the seating bottom portion 12, so that the care-receiver can reliably accept the posture change.

The front casters 15 are always grounded. While the front seating height of the chair waist bottom member 12b is a fixed height, the chair waist bottom member 12b becomes inclined rearward when the rear seating height D of the chair waist bottom member 12b is lowered relative to the front seating height. However, the care-receiver seated on the wheelchair 9 is supported by the chair back bottom member 12a. Thus, even upon rearward inclination, the care-receiver is not slipped downward from the wheelchair 9. Since the wheels are switched by the caster links 20 in conjunction with the posture change, the combination takes less time and efforts.

Since a position of the wheels to be grounded is changed between a case of the seating posture and a case of the flat posture in the wheelchair 9 (that is, since the position of the wheels is changed from a position on the lower side of the chair first bending portion 13j serving as a position of the traveling wheels 17 to a position on the lower side of the chair back bottom support member 13a serving as a position of the rear casters 16), the seating bottom portion 12 can be stably supported. Hereinafter, reasons thereof will be described.

In a case of the seating posture, most of weight of the care-receiver is applied to the chair waist bottom member 12b. However, in the flat posture, about a half of the weight of the care-receiver is applied to the chair back bottom member 12a. Therefore, in a case of the flat posture, when the grounded wheels are the traveling wheels 17 and the front casters 15, the traveling wheels 17 serve as a fulcrum, and ends on the front end side of the chair back bottom member 12a (on the opposite side of the chair waist bottom member 12b) may be sometimes inclined downward.

In a case where the seating bottom portion 12 is in the flat posture, as shown in FIG. 2B, the rear casters 16 are grounded on the lower side of the chair back bottom support member 13a (at a position on the front end side of the chair back bottom support member 13a rather than the chair first bending portion 13j). Thus, the seating bottom portion 12 in the flat posture can be stably supported.

Since the grounded rear casters 16 are grounded on the lower side of the chair back bottom support member 13a, the rear casters 16 stably support the wheelchair 9 in the flat posture.

Thereby, in the first embodiment, in the seating posture (the wheelchair state), the traveling wheels 17 are always arranged at positions closer to the front casters 15. Therefore, a turning radius of the wheelchair 9 in the seating posture is not increased, and as a result, an operability of the wheelchair 9 for example, in a narrow interior spate, is not deteriorated.

Further, in the flat posture, the rear casters 16 are always grounded on the lower side of the chair back bottom support member 13a. Therefore, gravity center balance at the time of lateral movement of the wheelchair 9 in the flat posture is stabilized, and turning of the wheelchair 9 in the flat posture is also stabilized.

FIG. 3 is a perspective view of the bed 11 in a combination preparation state. Next, with FIG. 3, the combination of the wheelchair 9 in the flat posture and the bed main body portion 10 will be described.

The bed main body portion 10 is composed of a bed bottom portion 31, a bed surface bottom support member 32 supporting the bed bottom portion 31, and a bed base portion 33 supporting the bed surface bottom support member 32. In the bed surface bottom support member 32, in the case where the wheelchair 9 and the bed main body portion 10 are combined, a protruding part (an exposed part in FIG. 3) of the bed surface bottom support member 32 is brought into contact with the seating bottom portion 12 so as to support not only the bed bottom portion 31 but also the seating bottom portion 12.

The bed main body portion 10 has a recess portion 34 serving as a combination area for arranging the chair base portion 14 of the wheelchair 9.

Firstly, in order to combine with the bed main body portion 10, the wheelchair 9 changed to the flat posture is arranged alongside the bed main body portion 10. Since the wheelchair 9 in the flat posture can be laterally moved, the wheelchair 9 can be closely attached to and combined with the bed main body portion 10. The seating bottom portion 12 and the bed bottom portion 31 combined in such a way can compose a bed surface without any gap between the seating bottom portion 12 and the bed bottom portion 31.

When the recess portion 34 serving as the combination area for arranging the chair base portion 14 is positioned in a recessed part of the bed surface bottom support member 32 and the bed main body portion 10, the combination is only performed from an arrow direction in FIG. 3. By using the wheelchair 9 of the first embodiment, the wheelchair 9 can be stably combined even with the bed main body portion 10 having such a configuration.

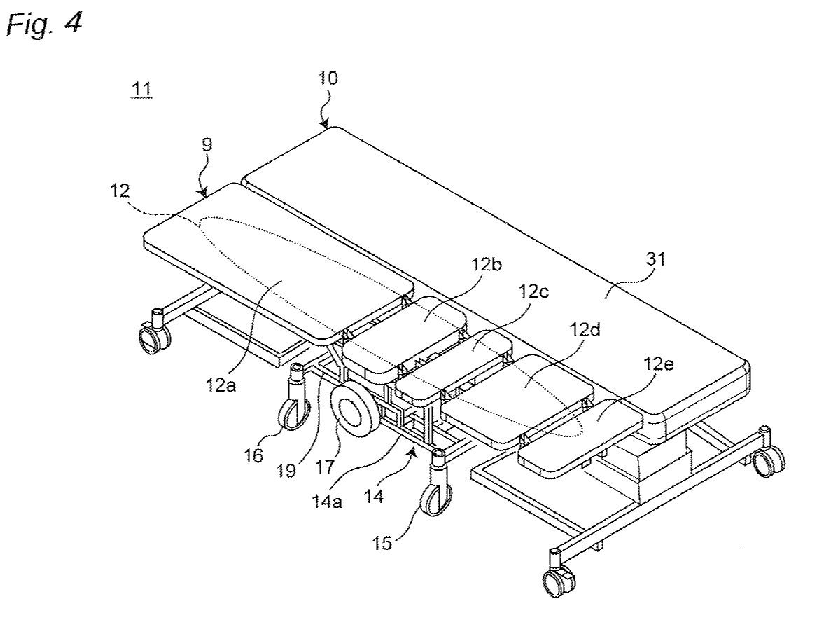

FIG. 4 is a perspective view of the combined bed 11. The bed 11 is composed of closely attaching the bed main body portion 10 and the wheelchair 9. Since the seating bottom portion 12 and the bed bottom portion 31 are closely attached, the care-receiver can utilize the bed 11 as a general bed without any discomfort.

In a state of the bed 11, the chair bottom support member 13 supports the seating bottom portion 12 but does not fix these. That is, in a state of the bed 11, the chair bottom support member 13 and the seating bottom portion 12 can be separated. Therefore, when the bed surface bottom support member 32 performs the posture change after the bed main body portion 10 and the wheelchair 9 are combined, the seating bottom portion 12 performs the posture change in accordance with this posture change of the bed surface bottom support member 32.

Furthermore, the wheelchair 9 of the first embodiment is also useful in the case where the care-receiver seated on the wheelchair 9 is transferred to a bed except for utilizing the wheelchair as one member composing the bed 11. In the wheelchair 9 of the first embodiment, the wheelchair 9 can be easily changed from the seating posture to the flat posture, laterally moved, and laterally placed alongside the bed. When the height of the bed is matched with the height of the wheelchair 9 in the flat posture, the care-receiver can be transferred from the wheelchair 9 to the bed without any burden.

In a state where the wheelchair 9 is in the seating posture, the brought-up rear casters 16 also play a role of preventing rollover of the wheelchair 9. When a caregiver pushes the wheelchair 9 in the seating posture so as to go over a level difference or the like, the front casters 15 firstly go upon the level difference, so that the wheelchair 9 is inclined rearward. At the time, there is a possibility that the caregiver cannot support the weight of the care-receiver and the wheelchair 9, and hence the wheelchair 9 may roll over. However, in the wheelchair 9 of the first embodiment, even in such a case, the rear casters 16 are grounded before the rollover. That is, the wheelchair 9 of the first embodiment prevents the rollover by utilizing the rear casters 16 serving as the wheels at the time of the flat posture as a rollover preventing mechanism at the time of the seating posture.

### Second Embodiment

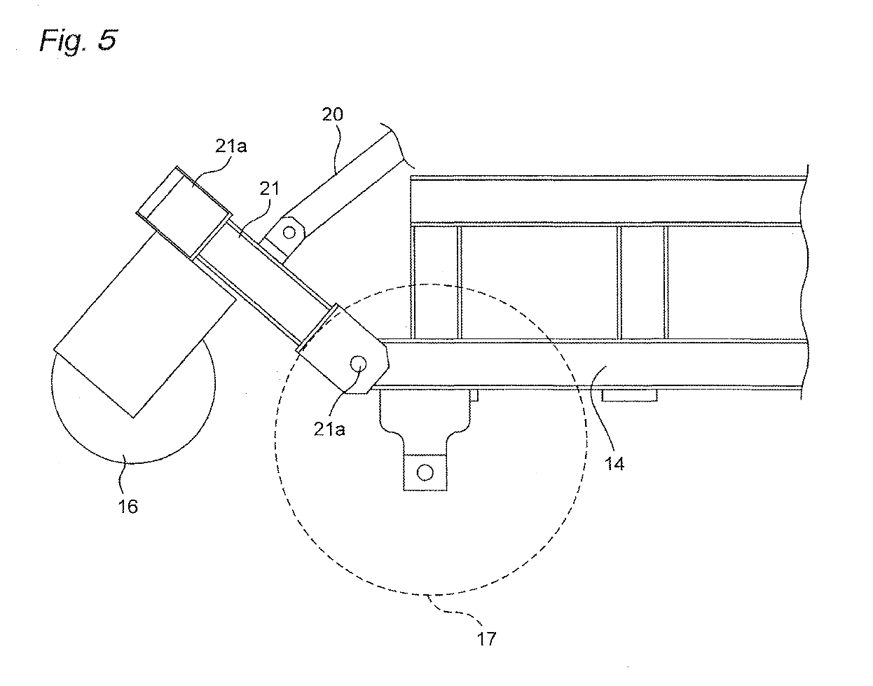

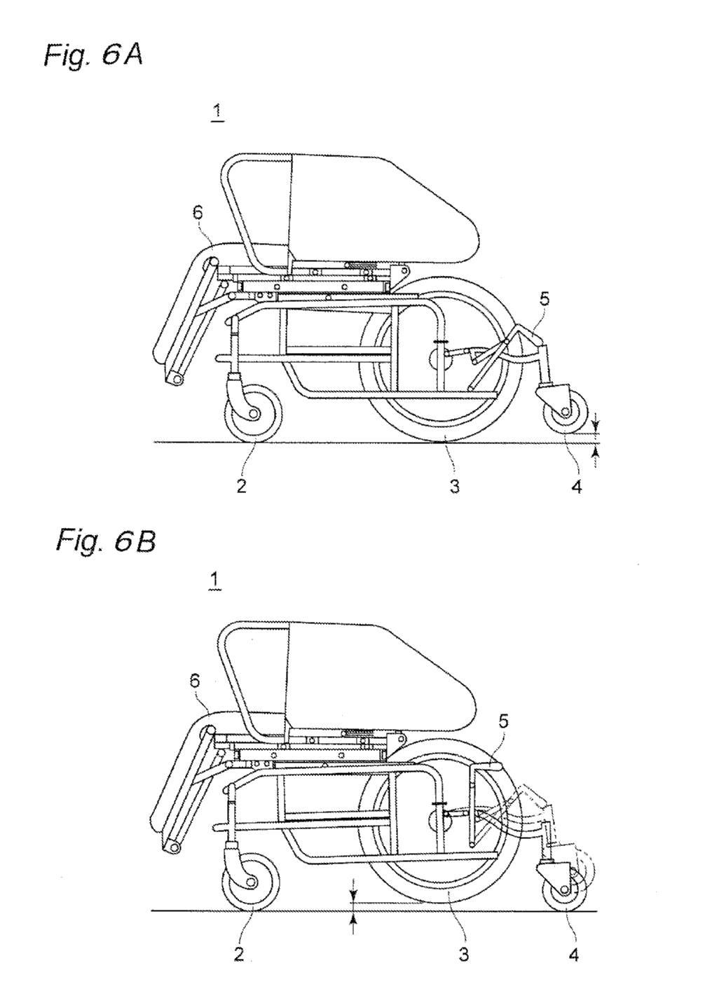

FIG. 5 is a partially enlarged view of a wheel switching mechanism of a second embodiment. The second embodiment is the same as the above first embodiment except the wheel switching mechanism. Therefore, in the second embodiment, only the wheel switching mechanism will be described.

In FIG. 5, the traveling wheel 17 is rotatably fixed to the rear part of the chair base portion 14. An end of a rear caster bottom support member 21 supporting the rear caster 16 is pivotably fixed to a rear end of the chair base portion 14 so as to be pivoted about a pivot shaft 21a. The caster link 20 is respectively fixed close to the vicinity of the rear caster 16 and the rotation shaft of the chair back bottom support member 13a. The rear caster bottom support member 21 is one example of a rear wheel bottom support member.

Hereinafter, an action of the wheel switching mechanism of the second embodiment will be described.

When the chair back bottom support member 13a and the chair back bottom member 12a are in a flat state, the rear casters 16 are grounded so as to be omnidirectionally moved. At this time, the chair waist bottom member 12b is horizontal.

When the chair back bottom support member 13a is brought up into the seating posture (the wheelchair state), the rear caster bottom support members 21 are pivoted about the pivot shafts 21a by the caster links 20. At this time, until the traveling wheels 17 are grounded, the chair base portion 14 is inclined rearward as the chair back bottom support member 13a is lifted. After the traveling wheels 17 are grounded, inclination of the chair base portion 14 is maintained to be inclination at the time point when the traveling wheels 17 are grounded, and the rear casters 16 are lifted as the chair back bottom support member 13a is lifted. Therefore, when the chair back bottom support member 13a is in the seating posture (the wheelchair state), the traveling Wheels 17 and the front caters 15 are grounded.

When the chair back bottom support member 13a is changed from the seating posture to the flat posture, the rear caster bottom support members 21 are pivoted about the pivot shafts 21a as the chair back bottom support member 13a is lowered, and the rear caster bottom support members 21 are lowered until the rear casters 16 are grounded. When the rear casters 16 are grounded, the traveling wheels 17 are brought up, and the chair base portion 14 comes close to being horizontal as the chair back bottom support member 13a is lowered. When the chair back bottom support member 13a becomes horizontal, the chair base portion 14 also becomes horizontal.

By the above action, the wheelchair 9 in the second embodiment is inclined slightly rearward in the seating posture. Thus, a possibility of downward slippage of the care-receiver from the wheelchair 9 can be reduced, and the same flat state as the bed can be maintained in the flat posture.

By appropriately combining arbitrary embodiments or modification examples among the above various embodiments or modification examples, effects provided in the embodiments and the modification examples can be obtained.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

By using the wheelchair of the present invention and the wheelchair to be combined with the bed as a part of the bed, an operation for combining the wheelchair with the bed main body portion can be easily performed, and the wheels can be switched with less time and efforts. Such a wheelchair is useful in an ordinary house, a hospital facility, and a nursing care facility where a person in need of care resides.

1-8. (canceled)

9. A wheelchair, comprising:
a seating bottom portion composed of a back bottom part, a seating bottom part, and a leg bottom part which are bendable to each other;
a chair bottom support member composed of a chair back bottom support member supporting the back bottom part and a chair leg bottom support member supporting the leg bottom part;
a link member for actuating the chair leg bottom support member in conjunction with an action of the chair back bottom support member;
a chair base portion coupled to the chair bottom support member;
front wheels serving as freewheels provided in a front part of the chair base portion;
wheel bottom support members whose intermediate parts are axially supported on a rear part of the chair base portion;
rear wheels serving as freewheels provided in one ends of the wheel bottom support members;
traveling wheels serving as fixed wheels provided in other ends of the wheel bottom support members; and
wheel links coupling rear wheel sides of the wheel bottom support members and the chair back bottom support member,
wherein in a case where the chair back bottom support member is lifted and the seating bottom portion is in a seating posture, lower surfaces of the traveling wheels are constantly positioned on a lower side of a plane composed of lower surfaces of the rear wheels and lower surfaces of the front wheels, and
in a case where the chair back bottom support member is brought down and the seating bottom portion is in a flat posture, the lower surfaces of the traveling wheels are constantly positioned on an upper side of the plane composed of the lower surfaces of the rear wheels and the lower surfaces of the front wheels.

10. A wheelchair, comprising:
a seating bottom portion composed of a back bottom part, a seating bottom part, and a leg bottom part which are bendable to each other;
a chair bottom support member composed of a chair back bottom support member supporting the back bottom part and a chair leg bottom support member supporting the leg bottom part;
a link member that actuates the chair leg bottom support member in conjunction with an action of the chair back bottom support member;
a chair base portion coupled to the chair bottom support member;
front wheels serving as freewheels provided in a front part of the chair base portion;
rear wheel bottom support members whose ends are axially supported on a rear part of the chair base portion;
a rear wheel serving as a freewheel provided in one end of the rear wheel bottom support member;
traveling wheels serving as fixed wheels provided on a rear side of the chair base portion; and
wheel links coupling rear wheel sides of the rear wheel bottom support members and the back bottom part of the chair bottom support member,
wherein in a case where the chair back bottom support member is lifted and the seating bottom portion is in a seating posture, lower surfaces of the traveling wheels are constantly positioned on a lower side of a plane composed of lower surfaces of the rear wheels and lower surfaces of the front wheels, and
in a case where the chair back bottom support member is brought down and the seating bottom portion is in a flat posture, the lower surfaces of the traveling wheels are constantly positioned on an upper side of the plane composed of the lower surfaces of the rear wheels and the lower surfaces of the front wheels.

11. The wheelchair according to claim 9, wherein in a case where the seating bottom portion is in the seating posture, the rear wheels are pulled up by the chair back bottom support member via the wheel links and the front wheels and the traveling wheels are grounded, and
in a case where the seating bottom portion is in the flat posture, the rear wheels are pushed down by the chair back bottom support member via the wheel links and the front wheels and the rear wheels are grounded.

12. The wheelchair according to claim 9, wherein the one ends of the wheel bottom support members in which the rear wheels are provided are rear ends of the wheel bottom support members, and the other ends of the wheel bottom support members in which the traveling wheels are provided are front ends of the wheel bottom support members.

13. The wheelchair according to claim 9, wherein the traveling wheels are fixed casters whose moving direction is fixed to a straight-moving direction.

14. The wheelchair according to claim 9, wherein in both states that the seating bottom portion is in the seating posture and the flat posture, an arrangement surface of the seating bottom part of the seating bottom portion is parallel to a support frame supporting the front wheels of the chair base portion and axially supporting parts of the both side wheel bottom support members.

15. A bed, comprising:
the wheelchair according to claim 9; and
a bed main body portion with which the wheelchair is separably combined.

16. The bed according to claim 15, wherein the bed main body portion has a recess portion in which the chair base portion is arranged.
